(19) United States
(12) Patent Application Publication
(10) Pub. No.: US 2004/0073363 A1
(43) Pub. Date: Apr. 15, 2004

(54) Electronic localizing protection device

(76) Inventors: Eliezer Sanchez, Homestead, FL (US); Daisy Sanchez, Homestead, FL (US)

Correspondence Address: David P. Lhota, Stearns Weaver Miller, et al., Suite 1900, 200 East Broward Boulevard, Fort Lauderdale, FL, 33301, US

(21) Appl. No.: 10/625,862

(22) Filed: Jul. 23, 2003

Related U.S. Application Data
(60) Provisional application No. 60/399,325, filed on Jul. 23, 2002.

(51) Int. Cl. G01C 21/20

(52) U.S. Cl. 701/213; 701/214

(57) ABSTRACT

An electronic localization protection device that calculates and transmits the position of a predetermined object, especially a person, and the optimal way to get to the predetermined target and comprises a GPS device having a receiver, processor and transmitter that receive signal data, calculate the exact coordinates of the target object and transmit that information to other tracking devices having a GPS receiver or local ground station, respectively and wherein the tracking devices comprise a tracking receiver that receives information from the target object, calculates its coordinates and determines the optimal way to get to the target from locale information stored in memory.

### CROSS REFERENCE TO RELATED APPLICATIONS

This application claims the benefit of U.S. provisional patent application serial No. 60/399,325, filed Jul. 23, 2003.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

This invention relates generally to a location device, and more particularly, to a device that locates the position of targeted items or people, calculates and transmits the exact coordinates, calculates the best way to get to the target and locates on a map the position of the target and tracker and plots the optimal way to get from the tracker to the target.

2. Description of the Background Art

It is well known that finding missing people and items of value is a difficult problem. In addition, even if the relative position can be obtained, the optimal path for reaching the item or person is uncertain. Some attempts have been made to develop reliable devices that can locate lost persons or items. However, they have been unreliable or too expensive or complicated to mass-produce and do not necessarily provide the optimal directions for reaching the item or person.

The devices and systems known in the art do not adequately address the foregoing issues as contemplated by the instant invention. For instance, U.S. Pat. No. 4,300,129, issued to Cataldo, discloses a concealable signaling device, such as a radio alarm, that is worn on a person and actuated by a concealed switch means that includes mechanical detents. The device includes a radio alarm transmitter on a belt that is activated when a wearer distends his waist. U.S. Pat. No. 5,014,040, issued to Weaver, discloses a personal locator transmitter adapted to be worn on the wrist and having the size and appearance of a conventional watch. The transmitter includes programmable memory, a transmitter, antenna and manually operable alarm actuated by pressing a button and automatic alarm actuated by an attempt to remove the unit from the wrist of the wearer. U.S. Pat. No. 5,021,794, issued to Lawrence, discloses a personal emergency locator system comprising a radio transmitter in a miniaturized transceiver concealed on a person to be located that transmits a coded UHF radio homing signal upon receipt of an initiating signal containing the address code. The patent further discloses a panic signal that can be activated by another person, such as a parent, and distance measuring equipment. U.S. Pat. No. 5,617,074, issued to White, discloses a child finder comprising a transmitter concealingly attachable to a child's body, such as in jewelry, and which sends a signal to a conventional receiver so that the child's location can be continually monitored. The patent further discloses a switch having a reciprocal push button which closes the transmitter's circuit and spring mechanism for opening the circuit when the device is not worn. U.S. Pat. No. 6,278,370, issued to Underwood, discloses a child locating and tracking apparatus including a transmitter, plurality of worldwide receivers, and means for activating the transmitter.

Although the above noted art discloses various location devices, they fail to adequately locate missing persons or items and provide an optimal path for reaching the designated location, as contemplated by the instant invention. The instant invention addresses this unfulfilled need in the prior art by providing a device and system that locates and transmits the exact coordinates of a target and provides an optimal path for reaching the located target.

### BRIEF SUMMARY OF THE INVENTION

In light of the foregoing, it is an object of the present invention to provide an electronic localization protection device that calculates and transmits the exact coordinates of a predetermined target.

It is another object of the instant invention to provide an electronic localization protection device that calculates and transmits the optimal way to get to a predetermined target.

It is a further object of the instant invention to provide an electronic localization protection device that locates on a map the position of a predetermined target and the position of a tracker and plots the optimal directions from the tracker to the target.

It is an additional object of the instant invention to provide an electronic localization protection device that immediately tracks the position of a lost person or item.

It is also an object of the instant invention to provide an electronic localization protection device that determines the position of a predetermined target within approximately three feet.

In light of these and other objects, the instant invention comprises an electronic localization protection device that calculates and transmits the position of a predetermined object, especially a person, and the optimal way to get to the predetermined target. The location device comprises a GPS transmitter coordinate device and a plurality of tracking devices. The GPS device has a receiver, processor and transmitter that receive signal data, calculate the exact coordinates of the target object and transmit that information to other tracking devices having a GPS receiver or local ground station, respectively. The tracking receiver receives information from the target object, calculates its coordinates and determines the optimal way to get to the target from locale information stored in memory. The location device is designed to save time when finding a target item or person. By tracking positions immediately and accurately, the time saved could save the lives of people or allow for quicker recovery of valuable items. In the preferred embodiment, the location of a tracked device or person can be accurate within three feet.

### BRIEF DESCRIPTION OF THE SEVERAL VIEWS OF THE DRAWINGS

FIG. 1 is a block diagram of the preferred embodiment of the location device in accordance with the instant invention.

FIG. 2 is another block diagram of the preferred embodiment of the location device in accordance with the instant invention.

FIGS. 3 and 4 are pictorial views of a housing that may be employed for the location device in accordance with the instant invention.

### DETAILED DESCRIPTION OF THE INVENTION

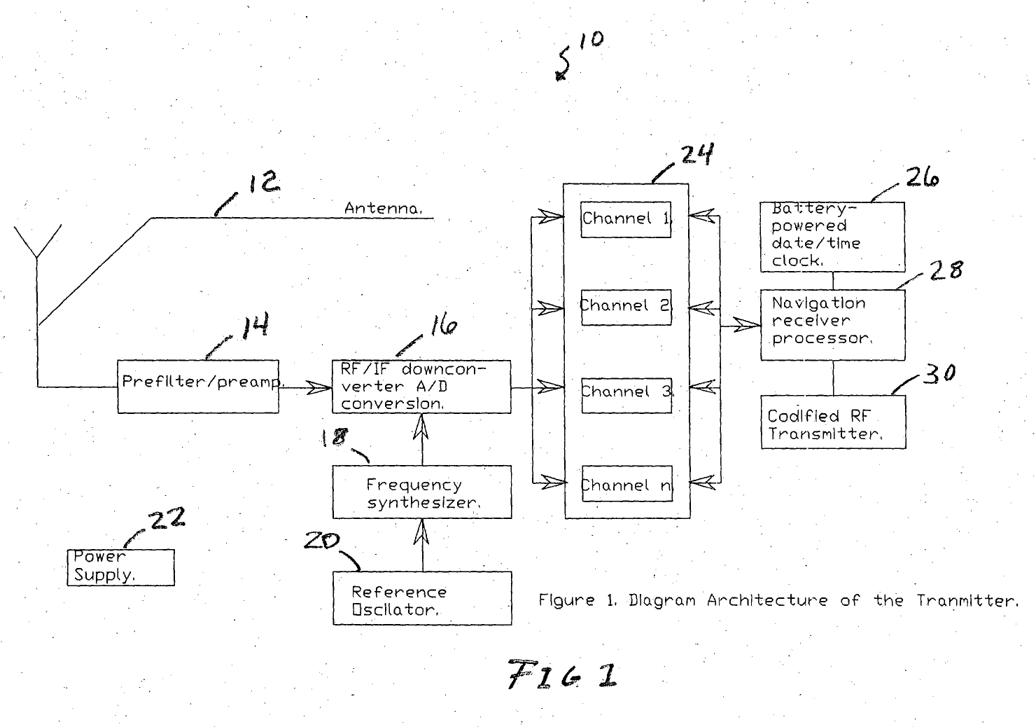

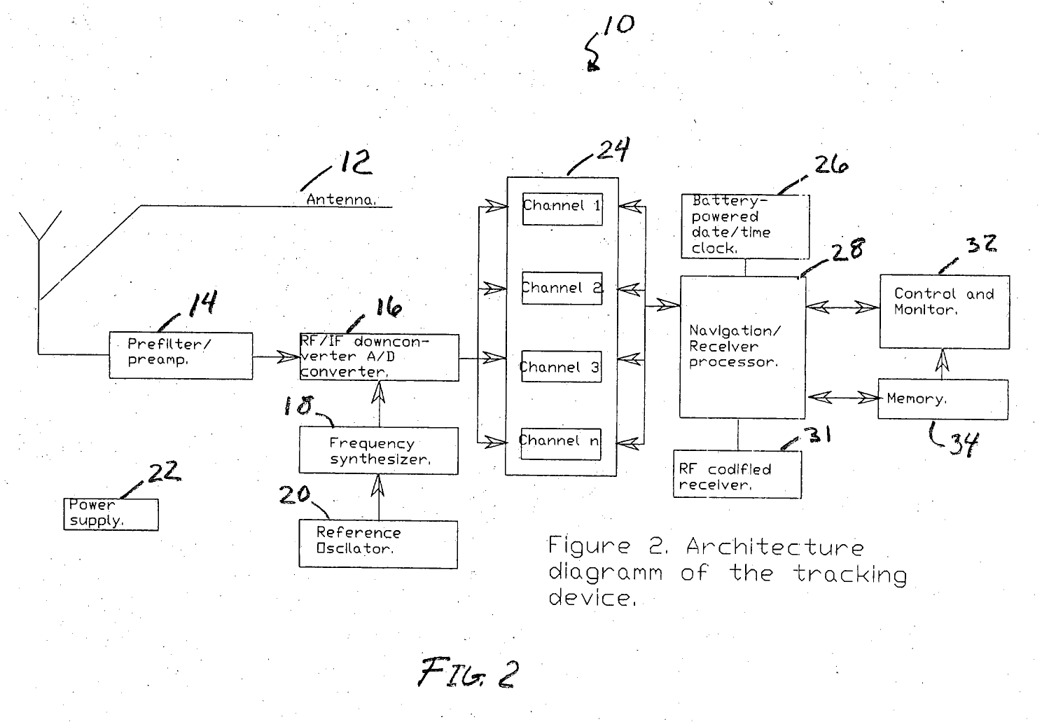

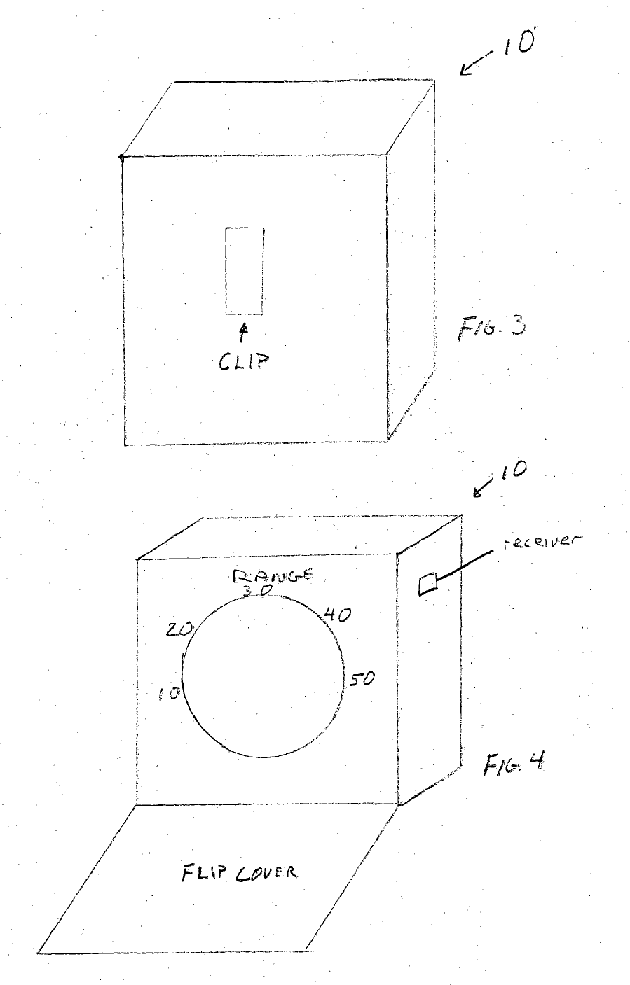

With reference to the drawings, FIGS. 1-4 depict the preferred and alternative embodiments of the instant invention which is generally referenced as a location device and, or by numeric character 10. With reference to FIGS. 1 and 2, the location device 10 comprises antenna 12, prefilter/preamplifier 14, RF/IF downconverter A/D conversion circuit 16, frequency synthesizer 18, reference oscillator 20, power supply 22, multiple-channel receiver 24, battery powered date/time clock 26, navigation receiver processor 28 (processor) and codified RF transmitter 30. The antenna 12 receives location related and specific information from targeted persons or items and transmits it to a prefilter/preamplification circuit 14. The antenna 12 captures information from different satellites or transmitter coordinates GPS devices and provides substantially hemispherical coverage. The preamp-circuit 14 forwards the conditioned signal to an RF/IF downconverter and, or A/D conversion circuit 16 which communicates with a frequency synthesizer 18 and reference oscillator 20 for additional signal conditioning prior to feeding the signal to the multiple channel receiver 24. The receiver 24 tracks information captured by the antenna, such as transmitter coordinates from a GPS device, and forwards it to the processor 28 for driving the coordinates. The receiver 24 has a plurality of channels for tracking information from one or more satellites. At least one of the channels receives transmitter coordinates from a GPS device. The processor 28 processes the signal and performs calculations for determining location information, such as accurate coordinates of the target object. The processor 28 calculates the exact coordinates of the tracking devices using the information received from the transmitter GPS device(s) and calculates the optimal way to get the target. The battery powered date/time clock 26 maintains time. The navigation receiver processor 28 further processes signals that are transmitted by the codified RF transmitter 30. The transmitter 30 receives information from the processor 28 and transmits the information in digital. By using digital, unauthorized tracking devices will not receive the information. The transmitter 30 transmits for short durations of time as determined and measured by the timer 26.

With reference to FIG. 2, the invention 10 may also incorporate an RF codified receiver 31 or transceiver. A control and monitor 32 can be used to locate the target point and the tracking point on a map, and plot the optimal way to get to the target in function of the local relieve and zone conditions. Information received, processed, derived and, or transmitted and local information may be stored in memory 34.

In accordance with the foregoing, the location device 10 locates and transmits the exact coordinates of a target to inform authorized authorities where to locate the target. The location device 10 may be manufactured in various clever shapes and sizes to be adapted to different types of situations. For example, the location device 10 may be inserted inside a decorative hair fastener, wrist-watch, heel of a shoe, and other articles. The location device 10 may also signal an alarm when the target has moved from the initial tracking position. The location device 10 should be manufactured from materials having high impact strength and vibration resistance, chemical resistance, low water absorption, low moisture absorption, and good reaction to different temperature environment. The location device 10 may be manufactured from materials such as Benelex, Diallyl Phthalate, Melamine, Phenol Formaldehyde, Polyethylene, Polypropylene and others having similar characteristics.

The manner of use of the location device 10 may depend on the shape and form of the housing where the electronic circuit of the transmitter coordinates GPS devices resides. For example, if the circuit has been camouflaged as a wristwatch, a button may be used to activate a transmitter when faced with a dangerous situation. If the circuit of the invention 10 is inserted in the heel of a shoe, the transmitter can automatically transmit a signal for predetermined durations, without requiring an external command or user intervention. When the transmitter coordinates GPS device is activated it synchronizes with the GPS satellite system and provides information on the screen or display monitor. The location device 10 is an improvement over the prior art whereby it tracks the target position and calculates the optimal way to get to the target.

The instant invention has been shown and described herein in what is considered to be the most practical and preferred embodiment. It is recognized, however, that departures may be made therefrom within the scope of the invention and that obvious structural and/or functional modifications will occur to a person skilled in the art.

What is claimed is:

1. An electronic target locating device that locates the coordinates of at least one target device and determines and determines directions for reaching the target device, said device comprising:
a global positioning system (GPS) transceiver coordinate device having means for communicating with a plurality of satellites, means for determining the location of at least one target device within a predetermined range and means for transmitting communications including information on the location of at least one target device; and
plurality of tracking devices for communicating with said GPS device, each of said tracking devices comprising means for communicating with said GPS device and at least one target, and means for determining a route for reaching the determined location of the target.

2. A device as recited in claim 1, wherein said means for communicating with a plurality of satellites comprises:
at least one antenna; and
an electronic receiver in communication with said at least one antenna and having a plurality of channels adapted for individually communicating with a plurality of satellites whereby each channel tracks the transmissions from a single satellite.

3. A device as recited in claim 1, wherein said means for determining the location of at least one target device comprises:
a computer processor and at least one set of processor readable software code adapted for calculating the location coordinates of at least one target.

4. A device as recited in claim 1, wherein said means for transmitting communications comprises:
a transmitter in communication with said means for determining adapted for transmitting location related in formation in digital format.

5. A device as recited in claim 1, wherein said GPS comprises:
means for receiving and supplying electrical power to said device.

6. A device as recited in claim 1, wherein said tracking device comprises:
means for communicating with said GPS device.

7. A device as recited in claim 6, wherein said means for communicating with said GPS device comprises:
at least one antenna; and
an electronic receiver adapted for communicating with said GPS device.

8. A device as recited in claim 6, wherein said tracking device further comprises:
a computer processor and at least one set of processor readable software code adapted for calculating the location coordinates of at least one target.

9. A device as recited in claim 8, wherein said tracking device further comprises:
a set of processor readable software code adapted for calculating at least one patch for reaching said least one target.

10. A device as recited in claim 6, wherein said tracking device further comprises:
a monitor for locating the target and tracking the target on a map.
